(19) United States
(12) Patent Application Publication
(10) Pub. No.: US 2026/0103233 A1
(43) Pub. Date: Apr. 16, 2026

(54) STEERING CONTROL SYSTEM AND METHOD

(71) Applicant: HL MANDO CORPORATION, Gyeonggi-do (KR)

(72) Inventors: Hyunbi KWON, Gyeonggi-do (KR); Jaehoon BAE, Gyeonggi-do (KR)

(21) Appl. No.: 19/084,745

(22) Filed: Mar. 19, 2025

(30) Foreign Application Priority Data
Oct. 16, 2024 (KR) 10-2024-0141613

(51) Int. Cl. B62D 5/04; B62D 5/00; B62D 15/02

(52) U.S. Cl. CPC B62D 5/046; B62D 5/006; B62D 5/0424; B62D 15/021

(57) ABSTRACT

The present embodiments relate to a steering control system and method. Specifically, a steering control system according to embodiments includes a steering feedback actuator (SFA) configured to drive a first steering motor to generate a steering feedback torque corresponding to a steering angle of a steering wheel received from a steering angle sensor, and a road wheel actuator (RWA) configured to determine a first target rack position based on the steering angle, and determine a second target rack position for adjusting the first target rack position if the SFA does not generate the steering feedback torque, and output a control signal to drive a second steering motor so as for a rack to move according to the first target rack position or the second target rack position.

### CROSS REFERENCE TO RELATED APPLICATION

This application claims priority from Korean Patent Application No. 10-2024-0141613, filed on Oct. 16, 2024, which is hereby incorporated by reference for all purposes as if fully set forth herein.

### TECHNICAL FIELD

An embodiment of the present disclosure relates to a steering control system and a steering control method for assisting the steering of a driver.

### BACKGROUND

In general, a steering device of a vehicle is a device that allows a driver to select and operate the direction of travel of the vehicle, and includes a steering handle or a steering wheel that the driver directly operates, and a steering mechanism that transmits the operating direction and operating power of the steering wheel to the wheels of a vehicle.

For example, power steering devices have been developed and applied to assist the driver's steering wheel operating power and provide convenience in driving operation. These power steering devices have been sequentially developed and applied, including hydraulic types using hydraulic pressure, electro-hydraulic types that simultaneously use hydraulic pressure and electric power of a motor, and electric types that use only the electric power of a motor. For example, an electric type using only the electric power of a motor may include a steer-by-wire steering device.

In this steer-by-wire steering device, since the rack linked to the vehicle's wheels is not mechanically connected to the steering wheel, it is required to arbitrarily generate a steering reaction force or a feedback torque and to provide to the steering wheel. In particular, if the steering reaction force is not provided, there may occur a sudden steering by the driver, so there is required a manner to improve the safety.

### SUMMARY

Embodiments of the present disclosure are to provide a steering control system and method in the steer-by-wire type steering device.

In accordance with an aspect of the present disclosure, there may be provided a steering control system including a steering feedback actuator (SFA) configured to drive a first steering motor to generate a steering feedback torque corresponding to a steering angle of a steering wheel received from a steering angle sensor, and a road wheel actuator (RWA) configured to determine a first target rack position based on the steering angle, and determine a second target rack position for adjusting the first target rack position if the SFA does not generate the steering feedback torque, and output a control signal to drive a second steering motor so as for a rack to move according to the first target rack position or the second target rack position.

In accordance with another aspect of the present disclosure, there may be provided a steering control method including receiving a steering angle of a steering wheel, determining a first target rack position based on the steering angle, and determining a second target rack position for adjusting the first target rack position if a steering feedback actuator (SFA) does not generate a steering feedback torque, and outputting a control signal so as for a rack to move according to the first target rack position or the second target rack position.

According to the present disclosure, it is possible to secure the steering stability of a vehicle in the steer-by-wire steering system.

### BRIEF DESCRIPTION OF THE DRAWINGS

FIG. 1 and FIG. 2 are drawings for explaining a steering control system according to one embodiment of the present disclosure.

FIG. 3 and FIG. 4 are drawings for explaining a relationship between a steering angle of a steering feedback actuator (SFA) 10 and a rack position of a road wheel actuator (RWA) 20 according to one embodiment.

FIG. 5 is a block diagram for briefly explaining a second steering control device according to one embodiment.

FIG. 6 is a block diagram for explaining a second steering control device according to another embodiment.

FIG. 7 is a flowchart for explaining a steering control method according to one embodiment of the present disclosure.

FIG. 8 is a drawing for more specifically explaining step S720 according to one embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described a steering control system according to one embodiment of the present disclosure with reference to the attached drawings.

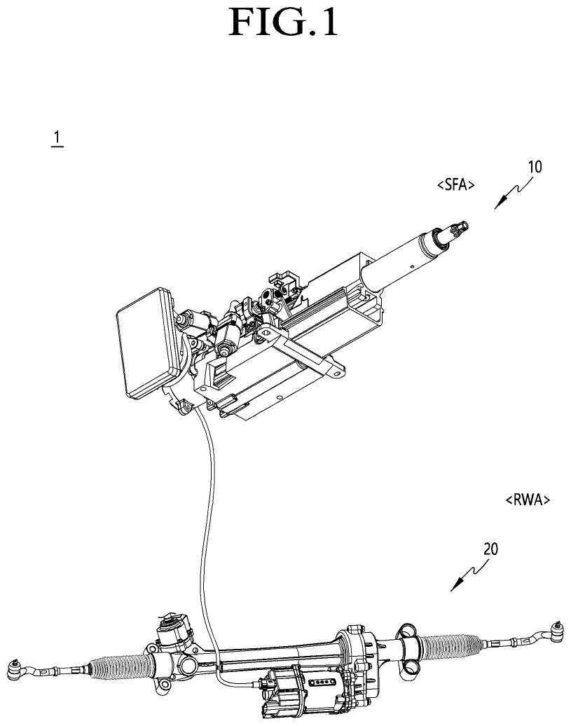

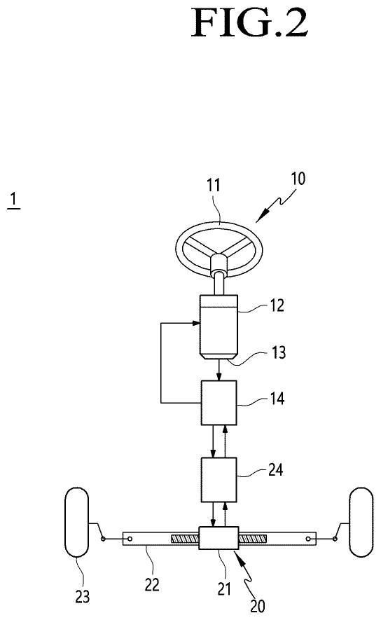

FIG. 1 and FIG. 2 are drawings for explaining a steering control system 1 according to one embodiment of the present disclosure.

Referring to FIG. 1, a steering control system 1 according to one embodiment of the present disclosure may mean a system that controls the steering of a vehicle equipped with a steering control system 1 according to a rotation angle of a steering wheel operated by a driver.

The steering control system 1 may be a steer-by-wire (SbW) system that transmits and receives electric signals through wires, cables, etc. between a SFA (Steering Feedback Actuator) 10 and an RWA (Road Wheel Actuator) 20 to transmit power.

The steering control system 1 according to an embodiment of the present disclosure may include an SFA 10 and an RWA 20, etc.

Referring to FIG. 2, the steering control system 1 according to the present disclosure illustrated in FIG. 2 may implement an SbW system with the SFA 10 and the RWA 20.

The SFA 10 may mean a device that inputs steering information intended by a driver. As described above, the SFA 10 may include a steering wheel 11, a steering shaft 12, a first steering motor 13, and a first steering control device 14. In addition, although not shown, the SFA 10 may further include a steering gear mechanism that transmits the rotational force of the first steering motor 13 to the steering shaft 12.

The steering wheel 11 may rotate between the left steering lock end and the right steering lock end with the steering shaft 12 as the rotational axis. Here, the lock end may mean a limit point at which the steering wheel can move. The lock end may include a steering damper, etc.

The first steering motor 13 may receive a control signal from the first steering control device 14 and provide a steering feedback torque or a steering reaction force to the steering wheel 11. In one embodiment, the first steering motor 13 may receive a control signal from the first steering control device 14, drive at a rotation speed indicated by the control signal to generate the steering feedback torque, and transmit the steering feedback torque to the steering wheel 11 through a worm and a worm wheel. In one embodiment, the steering feedback torque may be determined based on the steering angle of the steering wheel, the steering angle speed, and the speed information and angle information received from a motor position sensor (MPS) of the first steering motor. In this specification, the terms of the feedback torque, the steering feedback torque, and the steering reaction force may be used with the same meaning.

The SFA 10 may include a steering angle sensor that detects the steering angle of the steering wheel, a torque sensor that detects the driver torque, and a steering angle speed sensor that detects the steering angle speed of the steering wheel.

The first steering control device 14 may receive steering information from each sensor included in the SFA 10 and transmit the steering information to the second steering control device 24 described below, and may transmit information indicating a failure situation of the SFA to the second steering control device 24. Here, the steering information may mean information including at least one of a steering angle, a steering angle speed, and a driver torque.

Meanwhile, the first steering control device 14 can receive feedback on power information (e.g., rack position information) actually output from the RWA 20 to determine a control value, and output a control current indicating the control value to the first steering motor 13, thereby providing a steering feel (e.g., steering feedback torque) to the driver.

The RWA 20 may mean a device that drives an actual vehicle to steer. This RWA 20 may include a second steering motor 21, a rack 22, a wheel 23, and a second steering control device 24. In addition, the RWA 20 may further include a rack position sensor for detecting the position of the rack 22.

The second steering motor 21 may move the rack 22 in an axial direction. Specifically, the second steering motor 21 may be driven by receiving a control signal from the second steering control device 24, thereby causing the rack 22 to move linearly in the axial direction. That is, the rack 22 may move linearly between the left lock end, which is the left movement limit point, and the right lock end, which is the right movement limit point.

The rack 22 may perform linear movement by driving the second steering motor 21, and the wheel 23 may be steered left or right through the linear movement of the rack 22.

The second steering control device may receive information on the steering angle of the steering wheel 11 from the first steering control device 14 or the steering angle sensor, determine a target rack position corresponding to the steering angle, and output a control signal for moving the rack 22 to the target rack position.

Although not shown, the steering control system 1 may further include a clutch, which can separate or connect the SFA 10 and the RWA 20. Here, the clutch may be operated by the control of the first steering control device 14 or the second steering control device 15.

Meanwhile, when the steering control system 1 may be an SbW steering system and the vehicle may be driven in an autonomous driving mode, The steering control system 1 may perform steering control of the vehicle by controlling only the RWA 20, or may perform steering control of the vehicle by controlling both the SFA 10 and the RWA 20.

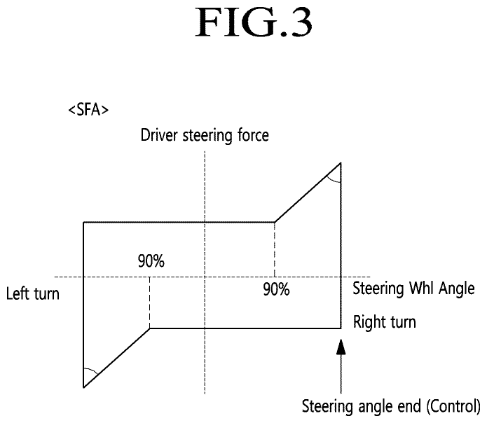

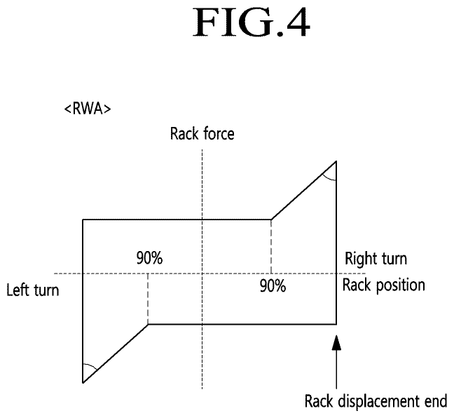

FIG. 3 and FIG. 4 are drawings for explaining the relationship between the steering angle of the SFA 10 and the rack position of the RWA 20 according to one embodiment.

Referring to FIGS. 3 and 4, in the normal state, if the steering wheel is steered in the SFA 10, a corresponding steering feedback torque is provided, thereby allowing the driver to steer the steering wheel based on the steering feedback torque. In addition, the RWA 20 may move the rack to a rack position corresponding to the steering angle of the steered steering wheel. Here, the RWA 20 may determine the target rack position by utilizing a C-Factor Map. The C-Factor MAP may mean a map in which the rack position corresponding to the steering angle is mapped. However, if the SFA 10 does not provide an appropriate steering feedback torque, there may occur a sudden steering different from the driver's steering intention. If a sudden steering occurs, the rack or a rack bar moves according to the steering angle of the steering wheel, and the wheel linked to the rack may be steered, so that the movement of the vehicle may become unstable.

Therefore, in the case of a failure state where the steering feedback torque is not provided, it is required to secure the stability of the vehicle steering by causing a response delay rather than directly moving the rack to the steering angle of the steering wheel in RWA 20.

To this end, a mechanical damping may be required, but the present disclosure proposes to provide a steering control system 1 capable of causing a response delay even without mechanical damping.

The steering control system 1 of the present disclosure may include an SFA 10 that receives a steering angle of a steering wheel from a steering angle sensor and drives a first steering motor to generate a steering feedback torque corresponding to the steering angle, and an RWA 20 that determines a first target rack position based on the steering angle, determines a second target rack position for adjusting the first target rack position if it is determined that the SFA 10 does not generate a steering feedback torque, and outputs a control signal to drive the second steering motor so that the rack moves to the first target rack position or the second target rack position.

The RWA 20 may determine whether the SFA 10 is in a loss of feedback torque state, i.e., a fault state in which a steering feedback torque is not generated. Information on this state may be transmitted from the first steering control device 14.

In addition, the second target rack position may be determined as the sum of the current rack position and the adjustment value.

Specifically, the RWA 20 may determine the second target rack position by utilizing the Equation 1 below.

$$Target rack position ( Damping ) = Current rack position + ( Target rack postion - Current rack postion ) * factor ( tuning value ) \qquad [ Equation 1 ]$$

Here, the adjustment value may be determined by multiplying a value obtained by subtracting the current rack position from the first target rack position by a factor.

The factor may be a value preset as a tuning value, and for example, the factor may be set to a value less than or equal to 1.

That is, the closer the factor is to 1, the more similar the second target rack position is to the first target rack position, which may mean a quick follow-up to the first target rack position.

According to the above, the steering control system 1 of the present disclosure may provide steering stability in case of sudden steering by determining the second target rack position in a failure situation.

In addition, In addition, the factor and the second target rack position may be determined by further considering a steering angle speed of the steering wheel. For example, the factor may be set to a lower value as the steering angle speed of the steering wheel is higher, and may be set to a higher value as the steering angle speed is lower.

In addition, the factor may be set to a lower value as the value obtained by subtracting the current rack position from the first target rack position is higher, and may be set to a higher value as the value obtained by subtracting the current rack position from the first target rack position is lower.

That is, if the steering wheel is over-steered and the steering angle speed is detected to be high, or the displacement between the first target rack position and the current rack position is detected to be a large value, the value of the second target rack position may be adjusted by dynamically setting the factor.

Accordingly, the steering control system 1 of the present disclosure may provide steering stability according to rapid steering by dynamically applying the factor to the steering angle speed or the displacement between the first target rack position and the current rack position.

In addition, the adjustment value may be determined based on the value obtained by dividing the steering angle speed by the preset angle speed.

Specifically, the adjustment value may be determined by utilizing the following Equation 2, and 720 deg/s may be preset as a tuning value. Additionally, the factor or a factor in Equation 2 may be set to a value less than or equal to 1.

$$Target rack position ( Damping ) = Current rack position + ( Target rack postion - Current rack postion ) * \{ 1 - ( Actual steering speed / 720 deg / 2 ( tuning value ) ) * factor ( tuning value ) \} \qquad [ Equation 2 ]$$

That is, as the driver's steering speed increases, the value of the second target rack position decreases, thereby allowing for a later follow-up with respect to the first target rack position.

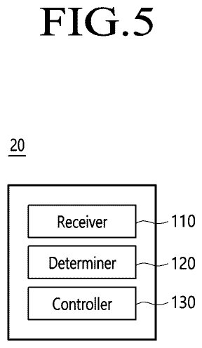

FIG. 5 is a block diagram for briefly explaining a second steering control device 24 according to one embodiment.

Referring to FIG. 5, the second steering control device 24 according to one embodiment may include a receiver 110, a determiner 120, and a controller 130.

The receiver 110 may receive information on the steering angle of the steering wheel, the steering angle speed, and whether the SFA 10 generates the steering feedback torque from the first steering control device 14.

The determiner 120 may determine the first target rack position based on the steering angle, and/or, if the SFA 10 does not generate the steering feedback torque, may determine the second target rack position.

In addition, the determiner 120 may determine the second target rack position by further considering the steering angle speed.

The controller 130 may output a control signal to the second steering motor so that the rack moves to the first target rack position or the second target rack position.

Meanwhile, the first target rack position or the second target rack position value may be determined directly in the SFA 10. In this case, the first steering control device 14 of the SFA 10 does not need to inform the second steering control device 24 in the RWA 20 of whether the SFA 10 has a failure in generating the steering feedback torque. That is, the SFA 10 may check if there is an abnormality in providing the steering feedback torque, determine the second target rack position, and provide information on the second target rack position to the RWA 20.

For example, the SFA 10 may receive information on the steering angle of the steering wheel from the steering angle sensor, drive the first steering motor to generate a steering feedback torque corresponding to the steering angle, and determine the first target rack position based on the steering angle. However, if it is determined that the SFA 10 cannot generate the steering feedback torque, the first target rack position may be adjusted to determine the second target rack position. In addition, the RWA 20 may receive information on the first target rack position or the second target rack position from the SFA 10 and output a control signal to move the rack to the first target rack position or the second target rack position to drive the second steering motor.

Accordingly, the SFA 10 perform may the determination of the first target rack position according to the steering angle, the determination of whether to generate steering feedback torque, and the determination of the second target rack position according to the determination result, as described above performed in the RWA 20.

In one embodiment, the first steering control device 14 and the second steering control device 24 may be implemented as a microcomputer or an electric controller unit (ECU).

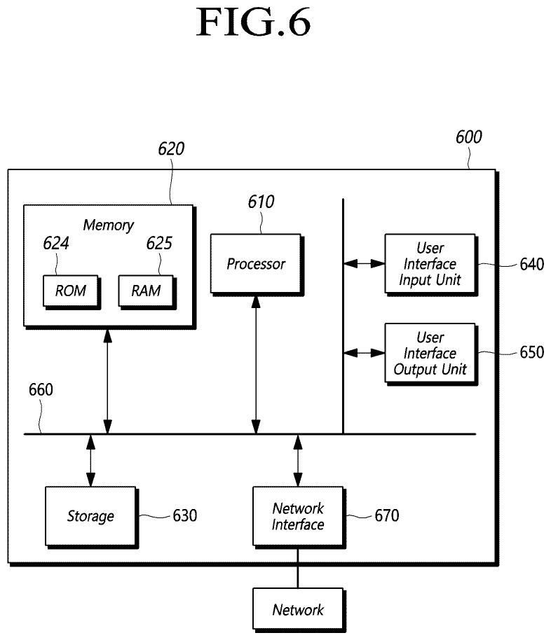

FIG. 6 is a block diagram for explaining a second steering control device 24 according to another embodiment.

The above-described present embodiments may be implemented in a computer system, for example, as a computer-readable recording medium. Referring to FIG. 6, a computer system 600 including the second steering control device 24 may include one or more elements of one or more processors 610, a memory 620, a storage 630, a user interface input unit 640, and a user interface output unit 650, and the elements may communicate with each other through a bus 660. In addition, the computer system 600 may also include a network interface 670 for connecting to a network. The processor 610 may be a central processor (CPU) or a semiconductor device that executes processing instructions stored in the memory 620 and/or the storage 630. The memory 620 and the storage 630 may include various types of volatile/nonvolatile storage media. For example, the memory may include a read-only memory (ROM) 624 and a random access memory (RAM) 625.

Hereinafter, it will be described a steering control method using a steering control system 1 capable of performing all of the above-described functions according to the present disclosures.

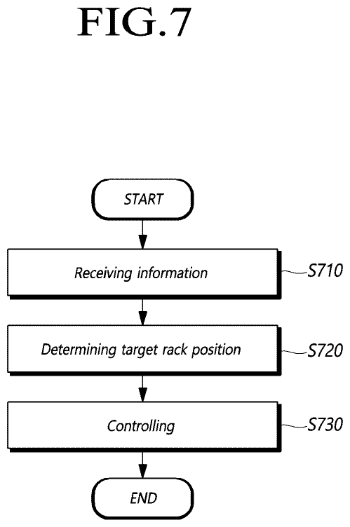

FIG. 7 is a flowchart for explaining a steering control method according to one embodiment of the present disclosure.

Referring to FIG. 7, a steering control method according to an embodiment of the present disclosure may include an information receiving step (S710) of receiving information on a steering angle of a steering wheel, a target rack position determining step (S720) of determining a first target rack position based on the steering angle and determining a second target rack position for adjusting the first target rack position if it is determined that the SFA 10 does not generate a steering feedback torque, and a control signal output step (S730) of driving a steering motor by outputting a control signal so that the rack moves to the first target rack position or the second target rack position.

Here, the second target rack position may be determined as the sum of the current rack position and the adjustment value.

The adjustment value may be determined by multiplying a factor by a value obtained by subtracting the current rack position from the first target rack position.

The factor may be preset as a tuning value, and for example, the factor may be set to a value less than or equal to 1.

The target rack position determination step (S720) may include determining the second target rack position by further considering the steering angle speed of the steering wheel.

In addition, the factor may be set lower as the steering angle speed of the steering wheel is higher, and may be set higher as the steering angle speed is lower.

The adjustment value may be determined based on a value obtained by dividing the steering angle speed by the preset angle speed.

In addition, the factor may be set lower as the value obtained by subtracting the current rack position from the first target rack position is higher, and may be set higher as the value obtained by subtracting the current rack position from the first target rack position is lower.

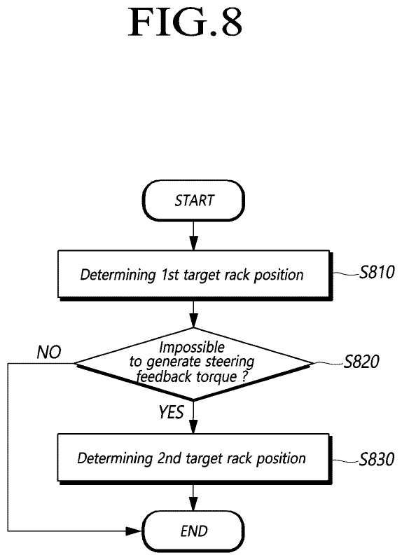

FIG. 8 is a drawing for more specifically explaining step S720 according to one embodiment.

Referring to FIG. 8, the steering control system may determine the first target rack position (S810).

the steering control system may determine whether the steering feedback torque cannot be generated in the SFA (S820).

If the steering feedback torque cannot be generated in the SFA (Yes in S820), the steering control system 1 may determine the second target rack position based on the current rack position, the first target rack position, and the steering angle speed (S830).

If the steering feedback torque can be generated in the SFA (No in S820), the steering control system 1 may drive the second steering motor to move the rack to the first target rack position.

As described above, according to the steering control system and method of the present disclosure, it is possible to secure the steering stability of the vehicle by preventing the wheels of the RWA from being suddenly steered even when the steering position suddenly changes due to the loss of the steering feedback torque of the SFA by generating a controllable response delay even without the presence of mechanical damping.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A steering control system comprising:
a steering feedback actuator (SFA) configured to drive a first steering motor to generate a steering feedback torque corresponding to information on a steering angle of a steering wheel received from a steering angle sensor; and
a road wheel actuator (RWA) configured to determine a first target rack position based on the steering angle, and determine a second target rack position for adjusting the first target rack position if the SFA does not generate the steering feedback torque, and output a control signal to drive a second steering motor so as for a rack to move according to the first target rack position or the second target rack position.

2. The steering control system of claim 1, wherein the second target rack position is determined by the sum of a current rack position and an adjustment value.

3. The steering control system of claim 2, wherein the adjustment value is determined by multiplying a factor by a value obtained by subtracting the current rack position from the first target rack position.

4. The steering control system of claim 3, wherein the factor is set to a value less than or equal to 1.

5. The steering control system of claim 3, wherein the RWA determines the second target rack position by further considering a steering angle speed of the steering wheel.

6. The steering control system of claim 5, wherein the factor is set to a lower value as the steering angle speed of the steering wheel is higher, and is set to a higher value as the steering angle speed is lower.

7. The steering control system of claim 5, wherein the adjustment value is determined based on a value obtained by dividing the steering angle speed by a preset angle speed.

8. The steering control system of claim 3, wherein the factor is set to a lower value as the value obtained by subtracting the current rack position from the first target rack position becomes higher, and the factor is set to a higher value as the value obtained by subtracting the current rack position from the first target rack position becomes lower.

9. A steering control method comprising:
receiving information on a steering angle of a steering wheel;
determining a first target rack position based on the steering angle, and determining a second target rack position for adjusting the first target rack position if a steering feedback actuator (SFA) does not generate a steering feedback torque; and
outputting a control signal so as for a rack to move according to the first target rack position or the second target rack position.

10. The steering control method of claim 9, wherein the second target rack position is determined by the sum of a current rack position and an adjustment value.

11. The steering control method of claim 10, wherein the adjustment value is determined by multiplying a factor by a value obtained by subtracting the current rack position from the first target rack position.

12. The steering control method of claim 11, wherein the factor is set to a value less than or equal to 1.

13. The steering control method of claim 11, wherein the determining a second target rack position includes determining the second target rack position by further considering a steering angle speed of the steering wheel.

14. The steering control method of claim 13, wherein the factor is set to a lower value as the steering angle speed of the steering wheel is higher, and is set to a higher value as the steering angle speed is lower.

15. The steering control method of claim 13, wherein the adjustment value is determined based on a value obtained by dividing the steering angle speed by a preset angle speed.

16. The steering control method of claim 11, wherein the factor is set to a lower value as the value obtained by subtracting the current rack position from the first target rack position becomes higher, and the factor is set to a higher value as the value obtained by subtracting the current rack position from the first target rack position becomes lower.

17. A steering control system comprising:
a steering feedback actuator (SFA) configured to drive a first steering motor to generate a steering feedback torque corresponding to information on a steering angle of a steering wheel received from a steering angle sensor, determine a first target rack position based on the steering angle, and determine a second target rack position for adjusting the first target rack position if the first steering motor does not generate the steering feedback torque; and
a road wheel actuator (RWA) configured to output a control signal to drive a second steering motor so as for a rack to move according to the first target rack position or the second target rack position.

18. The steering control system of claim 17, wherein the second target rack position is determined by the sum of a current rack position and an adjustment value.

19. The steering control system of claim 18, wherein the adjustment value is determined by multiplying a factor by a value obtained by subtracting the current rack position from the first target rack position.

20. The steering control system of claim 19, wherein the RWA determines the second target rack position by further considering a steering angle speed of the steering wheel.
